(19) United States
(12) Patent Application Publication
(10) Pub. No.: US 2025/0276739 A1
(43) Pub. Date: Sep. 4, 2025

(54) VEHICLE REAR STRUCTURE

(71) Applicant: TOYOTA JIDOSHA KABUSHIKI KAISHA, Toyota-shi (JP)

(72) Inventors: Tomoya AOH, Okazaki-shi (JP); Takayoshi Shigihara, Toyota-shi (JP)

(73) Assignee: TOYOTA JIDOSHA KABUSHIKI KAISHA, Toyota-shi (JP)

(21) Appl. No.: 18/983,407

(22) Filed: Dec. 17, 2024

(30) Foreign Application Priority Data
Mar. 1, 2024 (JP) 2024-031552

(51) Int. Cl. B62D 25/04; B62D 25/06; B62D 27/02

(52) U.S. Cl. CPC B62D 25/04; B62D 25/06; B62D 27/02

(57) ABSTRACT

The vehicle rear structure includes a roof side rail having a closed cross-sectional shape, a pillar extending in a vertical direction, one end of which is connected to the rear wheel house and the other end of which is connected to a portion in front of the rear end portion of the roof side rail, and a rear framework member positioned behind the pillar and having one end connected to the rear wheel house and the other end of which is connected to the rear end portion of the roof side rail.

### CROSS-REFERENCE TO RELATED APPLICATION

This application claims priority to Japanese Patent Application No. 2024-031552 filed on Mar. 1, 2024, incorporated herein by reference in its entirety.

### BACKGROUND

### 1. Technical Field

The present disclosure relates to a vehicle rear structure.

### 2. Description of Related Art

Japanese Unexamined Patent Application Publication No. 2021-116035 (JP 2021-116035 A) discloses a vehicle rear structure including a pair of right and left C pillars connecting rear portions of side sills and roof side rails.

### SUMMARY

The C pillar of JP 2021-116035 A has low rigidity against a rotational moment about a rotational axis extending in a vehicle width direction. Therefore, when a vertical force applied to a rear suspension of the patent document is transmitted to the C pillar, the C pillar is likely to rotate about the rotational axis. Thus, when the vertical force is applied to the vehicle rear portion, the vehicle rear portion is likely to deform. When the amount of deformation of the vehicle rear portion is large, the steering feeling of the steering wheel for the driver and the riding comfort of the occupant decrease.

In view of the above fact, it is an object of the present disclosure to provide a vehicle rear structure that is unlikely to deform when subjected to a vertical force.

A vehicle rear structure according to an aspect includes:
a roof side rail having a closed sectional shape;
a pillar extending in a vertical direction and including one end connected to a rear wheel house and another end connected to a portion forward of a rear end portion of the roof side rail; and
a rear framework member positioned on a vehicle rear side of the pillar and including one end connected to the rear wheel house and another end connected to the rear end portion of the roof side rail.

In the vehicle rear structure of the above aspect, the roof side rail has the

closed sectional shape. Therefore, the roof side rail is unlikely to deform in the vertical direction when subjected to a vertical force as compared with a case where the sectional shape of the roof side rail is an open section. The pillar extending in the vertical direction includes one end connected to the rear wheel house and the other end connected to the portion forward of the rear end portion of the roof side rail. The rear framework member positioned on the vehicle rear side of the pillar includes one end connected to the rear wheel house and the other end connected to the rear end portion of the roof side rail. Therefore, the pillar is unlikely to rotate about a rotational axis extending in a vehicle width direction when subjected to a vertical force as compared with a case where only the pillar is connected to the rear wheel house and the roof side rail. In this way, the roof side rail is unlikely to deform in the vertical direction and the pillar is unlikely to rotate about the rotational axis extending in the vehicle width direction when subjected to the vertical force. Thus, the vehicle rear structure of the above aspect is unlikely to deform when subjected to the vertical force.

In the vehicle rear structure of the above aspect, the rear framework member may extend in the vertical direction.

In the vehicle rear structure of the above aspect, the pillar is unlikely to rotate about the rotational axis extending in the vehicle width direction and the roof side rail is more unlikely to deform in the vertical direction when subjected to the vertical force as compared with a case where the rear framework member extends in a direction different from the vertical direction.

The vehicle rear structure of the above aspect may further include:
a rear side member;
a rear end connected to a rear end portion of the rear side member; and
a panel positioned on the vehicle rear side of the rear framework member and connected to the rear framework member and the rear end.

In the vehicle rear structure of the above aspect, bending of the rear side member in the vertical direction is easily suppressed by the action of the panel.

The vehicle rear structure according to the present disclosure has an excellent effect that it is unlikely to deform when subjected to the vertical force.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of a vehicle showing a vehicle rear structure according to an embodiment when viewed from behind;

FIG. 2 is a schematic side view of a vehicle rear structure;

FIG. 3 is a cross-sectional view taken along line 3-3 of FIG. 2;

FIG. 4 is a cross-sectional view taken along line 4-4 of FIG. 2;

FIG. 5 is a cross-sectional view taken along line 5-5 of FIG. 2;

FIG. 6 is a cross-sectional view taken along line 6-6 of FIG. 2;

FIG. 7 is a cross-sectional view taken along line 7-7 of FIG. 2; and

FIG. 8 is a cross-sectional view taken along line 8-8 of FIG. 4.

### DETAILED DESCRIPTION OF EMBODIMENTS

Hereinafter, an embodiment of a vehicle rear structure according to the present disclosure will be described with reference to the accompanying drawings. Note that an arrow FR appropriately shown in the drawings indicates the front side of the vehicle which is the front side in the vehicle front-rear direction, an arrow LH indicates the left side of the vehicle which is the left side in the vehicle left-right direction, and an arrow UP indicates the upper side of the vehicle which is the upper side in the vehicle vertical direction. In the following description, the front-rear direction, the left-right direction, and the up-down direction represent the vehicle front-rear direction, the vehicle left-right direction, and the vehicle up-down direction, respectively.

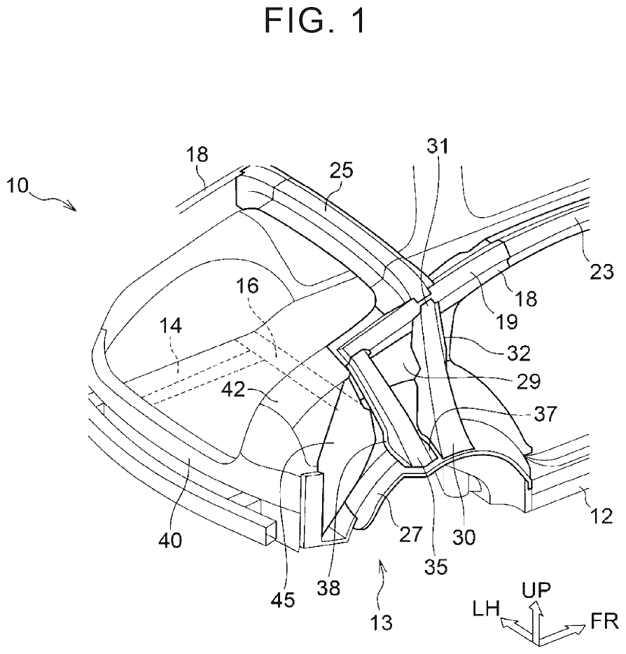

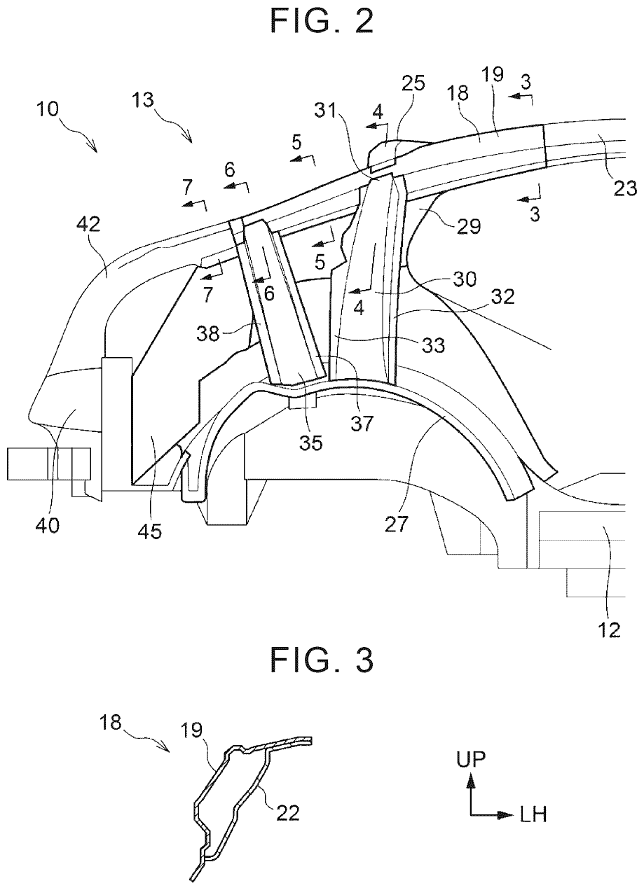

As shown in FIGS. 1 and 2, the vehicle rear structure 13 applied to the rear portion of the vehicle body 12 of the vehicle 10 includes a pair of left and right metal side sills (rockers) (not shown) which are separated from each other in the vehicle width direction (left-right direction) and extend in the front-rear direction, a pair of left and right metal rear side members 14 (only the left rear side member 14 is shown in FIG. 1) which are connected to the rear end of the side sills and extend toward the rear, and a metal cross member 16 (see FIG. 1) which is connected to the left and right rear side members 14 and extends in the left-right direction.

The vehicle rear structure 13 further includes a pair of left and right metal roof side rails 18 (only the right roof side rails 18 are shown in FIGS. 1 and 2) located above the left and right side sills and the rear side members 14 and extending in the front-rear direction apart from each other in the left-right direction, and a metal rear header 25 connecting the left and right roof side rails 18 and extending in the left-right direction.

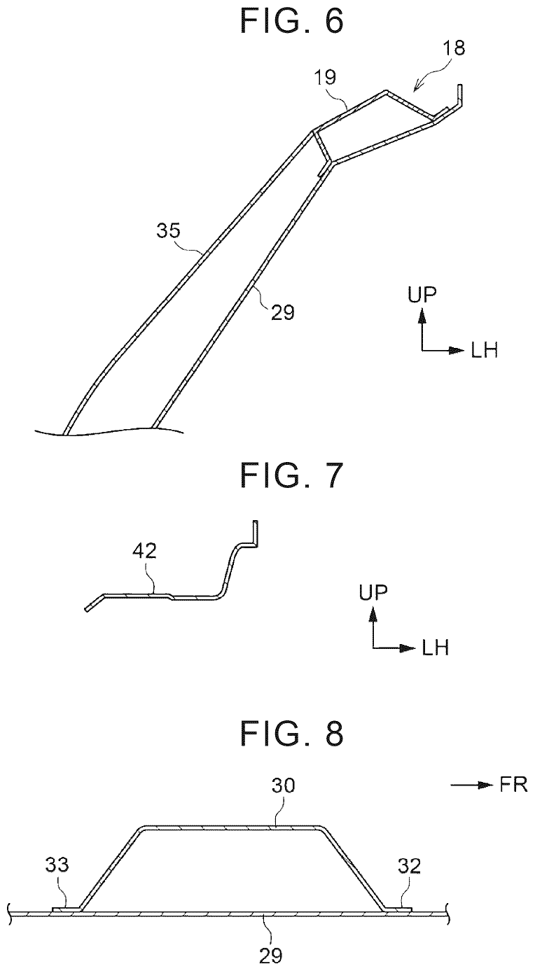

As illustrated in FIGS. 3 to 7, the roof side rail 18 is configured by coupling the outer rail 19, the inner rail 22, and the rear side panel 29 to each other. The outer rail 19 has the same length as the entire length of the roof side rail 18. The inner rail 22 is substantially parallel to the outer rail 19 and has a shorter overall length than the outer rail 19. The outer rail 19 and the inner rail 22 are integrally formed, and are manufactured by, for example, press molding.

As shown in FIG. 3, the front portion of the roof side rail 18 includes an outer rail 19 and an inner rail 22 located inside the outer rail 19. An upper edge portion and a lower edge portion of the outer rail 19 are fixed to the inner rail 22.

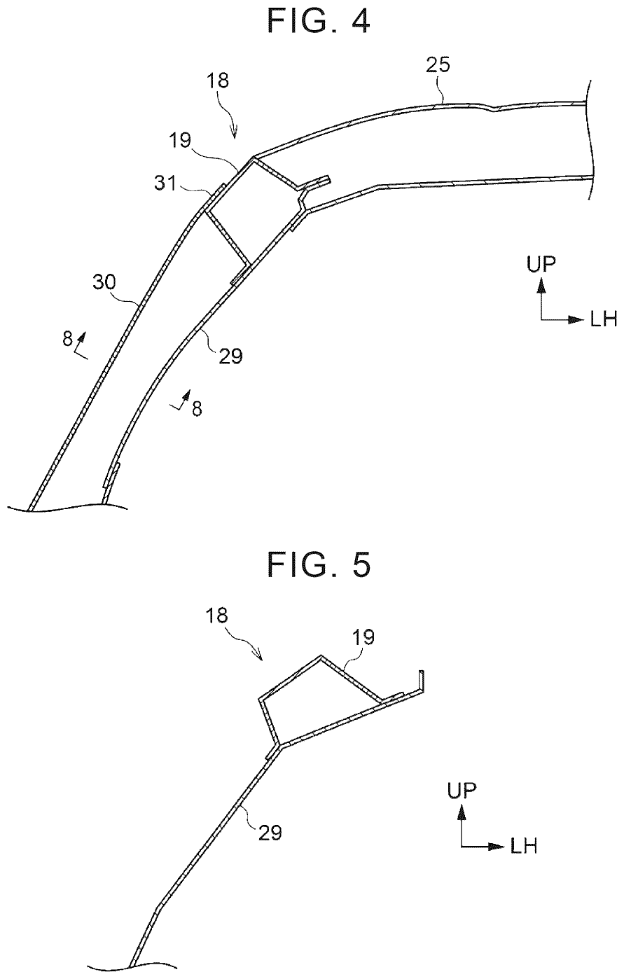

As shown in FIGS. 4 to 6, the portion located between the predetermined

portion and the rear end located behind the front end in the front-rear direction of the roof side rail 18 is constituted by the outer rail 19 and the upper portion of the metal rear side panel 29 located inside the outer rail 19. The upper edge portion and the lower edge portion of the outer rail 19 are fixed to the vehicle outer side surface of the rear side panel 29. The lower end portions of the left and right rear side panels 29 are connected to the left and right rear wheel houses 27, respectively.

As described above, the roof side rail 18 is composed of two members over its entire length. Therefore, at any position in the longitudinal direction of the roof side rail 18, the shape of the cross section cut in a plane orthogonal to the longitudinal direction of the roof side rail 18 is annular. That is, the roof side rail 18 has a closed cross-section over its entire length.

The front end portions of the left and right roof side rails 18 are connected to the rear end portions of the roof side rails 23 made of a metal different from the roof side rails 18.

The vehicle rear structure 13 includes a pair of left and right metal rear wheel houses 27. The left and right rear wheel houses 27 are connected to the left and right ends of the cross member 16. A rear wheel (not shown) is provided in an internal space of each rear wheel house 27.

As shown in FIGS. 1 and 2, a metal C-pillar 30 extending in the vertical direction in a side view and positioned outside the rear side panel 29 is positioned between the left and right rear wheel houses 27 and a portion positioned forward and rearward from the rear end of the left and right roof side rails 18. A flat connecting portion 31 is provided at an upper end portion of the C pillar 30. The cross-sectional shape of the portion located below the connecting portion 31 of the C pillar 30 is a substantially hat shape (see FIG. 8). A connection flange 32 is provided at a front edge portion of a portion located below the connecting portion 31 of the C pillar 30, and a connection flange 33 is provided at a rear edge portion. As shown in FIGS. 1 and 4, the connecting portion 31 is fixed to a portion that is in front of the rear end portion of the vehicle outer side surface of the outer rail 19 and in rear of the front end portion. The lower end portions of the connection flange 32 and the connection flange 33 are fixed to the vehicle outer surface of the rear wheel house 27, and 20 portions except the lower end portion and the upper end portion of the connection flange 32 and the connection flange 33 are fixed to the vehicle outer surface of the rear side panel 29.

Further, as shown in FIGS. 1 and 2, between the rear end portions of the left and right rear wheel houses 27 and the left and right roof side rails 18, a metal rear framework member 35 which is located at the vehicle rear side from the C pillar 30 and extends in the 25 vertical direction in a side view is located. The rear framework member 35 is located outside the rear side panel 29. In the present embodiment, the extension direction of the rear framework member 35 is inclined with respect to the extension direction of the C pillar 30 in a side view. The cross-sectional shape of the portion excluding the upper end portion of the rear framework member 35 is a substantially hat shape. A connection flange 37 is 30 provided at a front edge portion of a portion where the cross-sectional shape of the rear framework member 35 forms a substantially hat shape, and a connection flange 38 is provided at a rear edge portion. As shown in FIG. 1, the lower end portions of the connection flange 37 and the connection flange 38 are fixed to the vehicle outer surface of the rear wheel house 27, and portions except the lower end portion and the upper end portion of the connection flange 37 and the connection flange 38 are fixed to the vehicle outer surface of the rear side panel 29. Further, an upper end portion of the rear framework member 35 is fixed to the outer rail 19.

In the present specification, the term “the C pillar 30 extends in the up-down direction” in a side view includes a case where the extending direction of the C pillar 30 is completely parallel to the up-down direction and a case where the extending direction of the C pillar 30 is substantially parallel to the up-down direction. That is, inclination of the extension direction of the C pillar 30 in a range of a predetermined angle or less with respect to the up-down direction in the side view is included in “the C pillar 30 extends in the up-down direction in the side view”. Similarly, in the present specification, the term “the rear framework member 35 extends in the up-down direction” in a side view includes a case where the extension direction of the rear framework member 35 is completely parallel to the up-down direction and a case where the extension direction of the rear framework member 35 is substantially parallel to the up-down direction. That is, inclination of the extension direction of the rear framework member 35 in the side view within a range of a predetermined angle or less with respect to the up-down direction is included in “the rear framework member 35 extends in the up-down direction in the side view”. The predetermined angle is, for example, XX degrees.

A metal rear end 40 extending in the left-right direction is connected to the rear end portions of the left and right rear side members 14. Further, a front end of a D pillar 42 (only the D pillar 42 on the right side in FIG. 1) which is a metal elongated member is connected to a rear end of each of the left and right roof side rails 18. In a side view, the D pillar 42 is curved, and a rear end portion of each D pillar 42 is connected to the rear end 40. The opening surrounded by the rear header 25, the left and right roof side rails 18, the left and right D pillars 42, and the rear end 40 is an opening that is openably closed by a back door (not shown).

Further, a pair of left and right metal shear panels 45 are provided in a space formed between the rear wheel house 27, the rear side panel 29, the rear end 40, and the D pillar 42. The rear end portion of the shear panel 45 is connected to the rear end 40, the front portion of the lower portion of the shear panel 45 is connected to the rear wheel house 27, and the upper portion of the shear panel 45 is connected to the rear portion of the rear side panel 29 and the front end portion of the D pillar 42.

A rear suspension (not shown) is provided in a component (not shown) of the vehicle rear structure 13 different from the cross member 16 and the cross member 16. A part of the components of the rear suspension is connected to the left and right rear wheel houses 27.

### Action and Effect

Next, the operation and effects of the embodiment will be described.

When a force enters the traveling vehicle 10 from the road surface, this force is transmitted from the rear suspension to the rear portion of the vehicle body 12 (the rear wheel house 27), and the rear portion of the vehicle body 12 vibrates in the vertical direction.

However, the roof side rail 18 has a closed cross-sectional shape. Therefore, the roof side rail 18 is hardly deformed in the up-down direction when the rear portion of the vehicle body 12 is subjected to a force in the up-down direction as compared with a case where the cross-sectional shape of the roof side rail is an open cross-section.

Further, the roof side rail 18 having a long front-rear dimension (the front end being positioned forward of the C pillar 30) receives the force transmitted from the rear wheel house 27 to the roof side rail 18 via the rear side member 14, the rear end 40, the shear panel 45, and the D pillar 42 in its own axial direction (longitudinal direction). Therefore, when the rear portion of the vehicle body 12 is subjected to the vertical force, the rear end 40, the shear panel 45, and the D pillar 42 are hardly deformed.

Further, one end of the C pillar 30 extending in the up-down direction is connected to the rear wheel house 27, the other end is connected to a portion of the rear end portion of the roof side rail 18 in front of and behind the front end, one end of the rear framework member 35 positioned behind the vehicle from the C pillar 30 is connected to the rear wheel house 27, and the other end is connected to the rear end portion of the roof side rail 18. Therefore, compared to the case where only the C pillar 30 is connected to the rear wheel house 27 and the roof side rail 18, when the rear portion of the vehicle body 12 receives a force in the vertical direction, the C pillar 30 is hardly rotated around the rotation axis extending in the vehicle width direction, and the roof side rail 18 is hardly deformed in the vertical direction.

As described above, when the rear portion of the vehicle body 12 receives the vertical force, the roof side rail 18, the rear end 40, the shear panel 45, and the D pillar 42 are less likely to be deformed, and the C pillar 30 is less likely to rotate around the rotation axis extending in the vehicle width direction. Therefore, the vehicle rear structure 13 of the present embodiment is hardly deformed when the rear portion of the vehicle body 12 is subjected to a force in the vertical direction. Therefore, in the vehicle 10 of the present embodiment, when force enters from the road surface, the steering feeling of the steering wheel by the driver and the riding comfort of the occupant are unlikely to decrease.

Further, since the rear framework member 35 extends in the up-down direction in a side view, when the rear portion of the vehicle body 12 receives a force in the up-down direction as compared with the case where the rear framework member 35 extends in a direction different from the up-down direction in a side view, it is difficult for the C pillar 30 to rotate around the rotation axis extending in the vehicle width direction, and the roof side rail 18 is hardly deformed in the up-down direction.

The vehicle rear structure 13 further includes a rear end 40 connected to the rear end of the rear side member 14, a rear wheel house 27, a rear side panel 29, and a shear panel 45 connected to the D pillar 42. Therefore, the vehicle rear structure 13 is easier to suppress the vertical bending of the rear side member 14 than in the case where the shear panel 45 is not provided.

Further, when the C pillar 30 rotates around the rotation axis extending in the vehicle width direction, the D pillar 42, which is separated from the C pillar 30 by a predetermined distance rearward, receives the rotation moment around the C pillar 30. However, in the present embodiment, since the rotation of the C pillar 30 is suppressed, the rotational moment around the C pillar 30 received by the D pillar 42 is small. Therefore, when the rear portion of the vehicle body 12 is subjected to the vertical force, the D pillar 42 is hardly deformed. Further, since the D pillar 42 is hardly subjected to a large rotational moment, even if the structure of the D pillar 42 is simplified, large deformation of the D pillar 42 is hardly caused.

Although the vehicle rear structure according to the embodiment has been described above, the present disclosure can be appropriately modified in design without departing from the gist thereof.

For example, the extension direction of the rear framework member 35 in the side view may be parallel to the extension direction of the C-pillar 30.

What is claimed is:

1. A vehicle rear structure comprising:
a roof side rail having a closed sectional shape;
a pillar extending in a vertical direction and including one end connected to a rear wheel house and another end connected to a portion forward of a rear end portion of the roof side rail; and
a rear framework member positioned on a vehicle rear side of the pillar and including one end connected to the rear wheel house and another end connected to the rear end portion of the roof side rail.

2. The vehicle rear structure according to claim 1, wherein the rear framework member extends in the vertical direction.

3. The vehicle rear structure according to claim 2, further comprising:
a rear side member;
a rear end connected to a rear end portion of the rear side member; and
a panel positioned on the vehicle rear side of the rear framework member and connected to the rear framework member and the rear end.
